(19) United States
(12) Patent Application Publication
(10) Pub. No.: US 2026/0199840 A1
(43) Pub. Date: Jul. 16, 2026

(54) AERATION SYSTEM FOR DEFOULING ONE OR MORE LIQUID-FILTRATION MEMBRANES

(71) Applicant: HMT Technologies Inc., Mississauga (CA)

(72) Inventor: Hamid RABIE, Mississauga (CA)

(21) Appl. No.: 19/547,056

(22) Filed: Feb. 23, 2026

Related U.S. Application Data
(63) Continuation-in-part of application No. PCT/CA2025/051235, filed on Sep. 18, 2025.
Application No. PCT/CA2025/051235 is a continuation of application No. 19/041,018, filed on Jan. 30, 2025.
Application No. 19/041,018 is a continuation-in-part of application No. 18/888,278, filed on Sep. 18, 2024.

(51) Int. Cl. B01D 65/02; B01D 63/02

(52) U.S. Cl. CPC B01D 65/02; B01D 63/02; B01D 2315/06; B01D 2321/185

(57) ABSTRACT

An aeration system includes a chamber having a flow path structure that defines a multi-inlet gas flow path having a plurality of gas inlets and a flow path outlet, and including a first flow path portion extending downwardly, and a second flow path portion extending upwardly. A barrier is fluidically between the first and second flow path portions. The flow path outlet releases gas into the tank so as to defoul a filtration membrane in a tank. The multi-inlet gas flow path has a bottom, proximate to which is a sludge outlet. The sludge outlet is also a first retentate inlet. At least one second retentate inlet permits retentate to enter the multi-inlet gas flow path at a position to break bubbles present in the gas from a first size into a smaller second size.

### CROSS-REFERENCES TO RELATED APPLICATIONS

This application is a continuation-in-part of, and claims the benefit of, PCT Patent Application PCT/CA2025/051235, filed Sep. 18, 2025, which is a continuation of, and claims the benefit of, U.S. patent application Ser. No. 19/041,018, filed Jan. 30, 2025, which is a continuation-in-part of, and claims the benefit of U.S. patent application Ser. No. 18/888,278, filed Sep. 18, 2024, the contents of all of which are incorporated herein by reference in their entirety, where permitted.

### FIELD OF THE DISCLOSURE

The present invention relates to aeration systems for defouling one or more liquid filtration membrane modules and more particularly to aeration systems that employ intermittent aeration.

### BACKGROUND OF THE DISCLOSURE

Filtration membranes for filtering liquids are known in the art and exist in several forms, including, for example, hollow-fiber membranes and flat sheet membranes. Such membranes are typically provided in the form of modules, which are immersed in a tank of water that is to be filtered. As water passes through the wall of the membrane to the lumen or inside the channels of the sheet, contaminants in the water can collect on the exterior surface of the membrane.

For a number of years, aeration systems have been employed in the water tank to release bubbles of air that rise and interact with the membranes to clean the contaminants off the membranes. Some aeration systems employ an intermittent siphon effect, so as to release bubbles only intermittently. This is useful to reduce the amount of air that is released during operation, thereby reducing the cost of operation of these aeration systems.

There is a continuing need for improved performance and reduced cost in these aeration systems.

### SUMMARY OF THE DISCLOSURE

For the purposes of this disclosure “a filtration membrane” is intended to mean a hollow-fiber membrane, a flat sheet membrane or any other suitable type of membrane for filtering liquids.

In an aspect, the disclosure is directed to a pulse aeration system for an immersed membrane filtration system for mounting in a tank. The aeration system includes a chamber housing and a gas feed conduit. The chamber housing defines a plurality of chambers. Each chamber includes a riser conduit having a barrier having a barrier bottom that is positioned at a selected level in the chamber so as to release gas up the riser conduit when a gas level in the chamber reached below the barrier for release of the gas into the tank so as to defoul at least one filtration membrane in the tank. Each of the plurality of chambers has a chamber bottom that is open to permit retentate from the tank to be present in each of the plurality of chambers. The chamber housing includes a first wall defining at least one first wall gas inlet aperture into each of the plurality of chambers. The at least one first wall gas inlet aperture is positioned at an elevation that is within 3 cm of the barrier bottom. The gas feed conduit is in fluid communication with the at least one first wall gas inlet aperture for each chamber.

In some embodiments, for each of the plurality of chambers, the at least one first wall gas inlet aperture is a plurality of first wall gas inlet apertures.

In some embodiments, the at least one first wall gas inlet aperture is at least one upper first wall gas inlet aperture and is spaced from a bottom of the first wall. The first wall defines at least one lower first wall gas inlet aperture that is positioned at the bottom of the first wall. Optionally, each of the at least one lower first wall gas inlet aperture has a cross-sectional area that is greater than the cross-sectional inlet area for each of the at least one upper first wall gas inlet aperture.

In some embodiments, the pulse aeration system further includes a distributor that is positioned on top of the riser conduit. The distributor includes a plurality of distributor outlets that are oriented so as to distribute gas leaving the riser conduit in the plurality of directions, so as to distribute the gas to a first side of a group of the filtration membranes and to a second side of the group of filtration membranes. Optionally, the distributor is positioned beneath the first group of the filtration membranes and beneath a second group of the filtration membranes. Further optionally, the plurality of distribution conduit outlets includes a plurality of first distributor outlets, a plurality of second distributor outlets and a plurality of third distributor outlets. The plurality of first distributor outlets are positioned to distribute the gas on a first side of the first group of the filtration membranes, the plurality of second distributor outlets are positioned to distribute the gas on a first side of the second group of the filtration membranes, and the plurality of third distributor outlets are positioned to distribute the gas between the first and second groups of filtration membranes, so as to be on a second side of the first group of the filtration membranes and on a second side of the second group of the filtration membranes.

In some embodiments, the gas feed conduit has a gas feed conduit cross-sectional area. The at least one first wall gas inlet aperture into each of the plurality of chambers defines a total cross-sectional inlet area for the at least one first wall gas inlet aperture. A ratio of the gas feed conduit cross-sectional area to the total cross-sectional inlet area for at least one first wall gas inlet aperture is greater than a selected value, such that a gas pressure at each one of the at least one first wall gas inlet apertures for all of the plurality of chambers differs from one another by less than 5 percent.

In some embodiments, the chamber housing includes a second wall. The second wall defines at least one second wall gas inlet aperture into each of the plurality of chambers, the at least one second wall gas inlet aperture being positioned at an elevation that is within 3 cm of the barrier bottom. The gas feed conduit is a first gas feed conduit. The aeration system further comprises a second gas feed conduit extending parallel to the second wall. The second gas feed conduit is in fluid communication with the at least one second wall gas inlet aperture for each chamber. The second gas feed conduit has a bottom that is open so as to permit retentate to enter the second gas feed conduit. Optionally, the second gas feed conduit has a second gas feed conduit cross-sectional area. The at least one second wall gas inlet aperture into each of the plurality of chambers defines a total cross-sectional inlet area for the at least one second wall gas inlet aperture. A ratio of the second gas feed conduit cross-sectional area to the total cross-sectional inlet area for at least one second wall gas inlet aperture is greater than a selected value, such that a gas pressure at each one of the at least one second wall gas inlet apertures for all of the plurality of chambers differs from one another by less than 5 percent.

In some embodiments, the gas feed conduit has a bottom that is open so as to permit retentate to enter the gas feed conduit.

In some embodiments, the pulse aeration system further includes a cup that surrounds the riser conduit. Optionally, the cup has a cup bottom end that has a cup aperture to permit retentate to enter the cup.

In another aspect, the disclosure is directed to a pulse aeration system for an immersed membrane filtration system for mounting in a tank. The aeration system includes a chamber housing defining at least one chamber. Each of the at least one chamber includes a gas inlet to permit an entry of a gas therein and a liquid inlet to permit an entry of retentate from the tank therein. Each of the at least one chamber includes a flow path structure defining a flow path having a flow path inlet and a flow path outlet. The flow path includes a first flow path portion that extends downwardly downstream from the flow path inlet, and a second flow path portion that extends upwardly upstream from the flow path outlet and downstream from the first flow path portion. The flow path structure defines a barrier that is fluidically between the first and second flow path portions. The barrier has a barrier bottom that is positioned at a selected level in the chamber so as to permit a gas release event during which the gas is released up the second flow path portion from the first flow path portion when a gas level of the gas in the flow path reaches below the barrier bottom. The flow path outlet is positioned for release of the gas into the tank so as to defoul a plurality of filtration membranes in the tank. The flow path has a bottom. The flow path structure includes a flow path aperture proximate the bottom of the flow path to permit sludge in the flow path to fall therethrough. An area of the flow path aperture is between 2% and 12% of an area of the flow path at the barrier bottom. Each of the at least one chamber has a bottom that is open beneath the flow path aperture, so as to permit any sludge that falls through the flow path aperture to leave the chamber.

In some embodiments, the bottom that is open is the liquid inlet.

In some embodiments, at least a portion of the flow path aperture is positioned directly beneath the barrier bottom.

In some embodiments, the flow path aperture permits an entry of the retentate into the flow path after an initiation of the gas release event, so as to seal the second flow path portion so as to end the gas release event. The area of the flow path aperture is selected so as to be less than a selected size so as to prevent more than a 10% variation in each of a magnitude of successive ones of the gas release events, a frequency of the gas release events, and periods between successive ones of the gas release events. In some embodiments, the area of the flow path aperture is selected so as to be less than a selected size so as to prevent more than a 5% variation in each of a magnitude of successive ones of the gas release events, a frequency of the gas release events, and periods between successive ones of the gas release events. Accordingly, in such embodiments (where the aforementioned variation is less than 10% and particularly where the aforementioned variation is less than 5%), each of a magnitude of successive ones of the gas release events, a frequency of the gas release events, and the periods between successive ones of the gas release events are consistent, and not random. For the purposes of the present disclosure, “not random” is to be construed as meaning “consistent”.

In some embodiments, a cross dimension of the flow path aperture is between 3 mm and 8 mm. Optionally, the flow path aperture is circular.

In some embodiments, the pulse aeration system further includes a distributor that is positioned on top of the flow path outlet. The distributor includes a plurality of distributor outlets that are oriented so as to distribute gas leaving the flow path outlet in a plurality of directions, so as to distribute the gas to a first side of the plurality of filtration membranes and to a second side of the plurality of filtration membranes.

In some embodiments, the flow path structure includes a riser conduit that defines the second flow path portion, the flow path outlet and the barrier, and a cup that surrounds the riser conduit so as to define the first flow path portion, and the flow path inlet. The flow path aperture is at a bottom of the cup.

In yet another aspect, the disclosure is directed to a membrane module that includes a plurality of hollow-fiber membranes and a pulse aeration system. The hollow-fiber membranes are arranged proximate to one another and mounted to permit at least a selected amount of lateral movement during operation. The hollow-fiber membranes each have a first end supported at a first connection point on a first header, and have a second end fixed supported at a second connection point on a second header. The hollow-fiber membranes have at least 2% slack to permit lateral movement of the hollow-fiber membranes. The pulse aeration system has at least one flow path with at least one flow path outlet through which a non-random pulsed gas flow is introduced for cleaning outer surfaces of the hollow-fiber membranes, and a device connected in fluid communication with a distributor to substantially uniformly distribute pulsed gas bubbles that make up the non-random pulsed gas flow into the membrane module.

In some embodiments, the non-random pulsed gas flow is made up of a plurality of gas release events of the pulsed gas bubbles, and at most a 10% variation in each of a magnitude of successive ones of the gas release events, a frequency of the gas release events, and periods between successive ones of the gas release events. In some embodiments, the area of the flow path aperture is selected so as to be less than a selected size so as to prevent more than a 5% variation in each of a magnitude of successive ones of the gas release events, a frequency of the gas release events, and periods between successive ones of the gas release events. Accordingly, in such embodiments each of the magnitude of successive ones of the gas release events, the frequency of the gas release events, and the periods between successive ones of the gas release events are highly consistent, and not random.

In some embodiments, the membrane module further includes a distributor that is positioned on top of each of the at least one flow path outlet. The distributor includes a plurality of distributor outlets that are oriented so as to distribute gas leaving the at least one flow path outlet in a plurality of directions, so as to distribute the gas to a first side of the plurality of hollow-fiber membranes and to a second side of the plurality of hollow-fiber membranes.

In some embodiments, each of the at least one flow path is defined by a flow path structure that includes a riser conduit that defines a second flow path portion, the flow path outlet and a barrier, and a cup that surrounds the riser conduit so as to define the first flow path portion and a flow path inlet. The barrier has a barrier bottom that is positioned at a selected level in the chamber so as to permit a gas release event during which the gas is released up the second flow path portion from the first flow path portion when a gas level of the gas in the flow path reaches below the barrier bottom. The flow path outlet is positioned for release of the gas into the tank so as to defoul a plurality of hollow-fiber membranes in the tank. The flow path has a bottom. The flow path structure includes a flow path aperture proximate the bottom of the flow path. An area of the flow path aperture is between 2% and 12% of an area of the flow path at the barrier bottom. The flow path aperture is sized to permit sludge in the flow path to pass therethrough to exit the flow path.

In yet another aspect, the disclosure is directed to a method for defouling a plurality of filtration membranes in a membrane module that is immersed in a tank containing a retentate, the method comprising:
providing an aeration system containing a chamber that contains the retentate;
providing a flow path structure defining a flow path having a flow path inlet and a flow path outlet, the flow path structure including a barrier having a barrier bottom, and a flow path aperture positioned along the flow path between the flow path inlet and the flow path outlet;
introducing gas into the chamber so as to lower a level of the retentate in the chamber, such that, after a selected period of time, the gas lowers the level of the retentate to break a hydraulic seal at the barrier bottom, thereby release some of the gas past the barrier bottom to exit the flow path outlet, in such a way that the gas passes along the plurality of filtration membranes so as to defoul the plurality of filtration membranes, wherein each of a magnitude of successive ones of the gas release events, a frequency of the gas release events, and the selected period of time between successive moments upon which the hydraulic seal is broken varies by less than 10%.

In some embodiments, the plurality of filtration membranes are a plurality of hollow-fiber membranes. The plurality of hollow-fiber membranes are each mounted longitudinally between a first connection point to a first header and a second connection point to a second header. The hollow-fiber membranes have more than 2% slack to permit lateral movement of the hollow-fiber membranes.

In some embodiments, the introducing step introduces gas at a constant gas flow rate into the chamber. After a gas release event in which the some of the gas is released past the barrier bottom, the retentate enters into the flow path through the flow path aperture and through the flow path inlet to reform the hydraulic seal. Optionally, the flow path aperture has an area that is between 2% and 12% of an area of the flow path at the barrier bottom, and is sized to permit sludge in the flow path to pass therethrough to exit the flow path. Further optionally, a cross dimension of the flow path aperture is between 3 mm and 8 mm.

In some embodiments, the chamber has a bottom that is open so as to permit retentate to enter the chamber.

In yet another aspect, a pulse aeration system is provided for mounting in a tank for use with an immersed filtration system. The pulse aeration system includes a chamber housing that defines a chamber having a flow path structure that defines a multi-inlet gas flow path having a plurality of gas inlets and a flow path outlet. The multi-inlet gas flow path includes a first flow path portion that extends downward downstream from a first end thereof, and a second flow path portion that extends upwardly upstream from the flow path outlet and downstream from the first flow path portion. The flow path structure defines a barrier that is fluidically between the first and second flow path portions. The barrier has a barrier bottom that is positioned at a selected level in the chamber so as to permit a gas release event during which the gas is released up the second flow path portion where the gas come from the first flow path portion when a gas level of the gas in the flow path reaches below the barrier bottom. The flow path outlet is positioned for release of the gas into the tank so as to defoul at least one filtration membrane in the tank. The multi-inlet gas flow path has a bottom. The flow path structure includes a sludge outlet proximate the bottom of the multi-inlet gas flow path to permit sludge in the flow path structure to fall therethrough. The chamber has a bottom that is open beneath the sludge outlet so as to permit any sludge that falls through the sludge outlet to leave the chamber. The sludge outlet is a first retentate inlet thereby permitting retentate to enter the multi-inlet gas flow path. The flow path structure further includes at least one second retentate inlet that is positioned to permit retentate to enter the multi-inlet gas flow path at a position to interact with the gas during a gas release event so as to break bubbles present in the gas from a first size into a second size that is smaller than the first size.

In yet another aspect, a pulse aeration system is provided for mounting in a tank for use with an immersed filtration system. The pulse aeration system includes a chamber housing defining a chamber having a flow path structure that defines a gas flow path having at least one gas inlet and a flow path outlet. The at least one gas inlet includes at least one bottom gas inlet that is positioned proximate a bottom of the gas flow path and is directly fluidically connected to a gas feed conduit for transporting a gas into the gas flow path from a gas source. The gas flow path includes a first flow path portion that extends downward downstream from a first end thereof, and a second flow path portion that extends upwardly upstream from the flow path outlet and downstream from the first flow path portion, the flow path structure defining a barrier that is fluidically between the first and second flow path portions. The barrier has a barrier bottom that is positioned at a selected level in the chamber so as to permit a gas release event during which the gas is released up the second flow path portion from the first flow path portion, when a gas level of the gas in the flow path reaches below the barrier bottom. The flow path outlet is positioned for release of the gas into the tank so as to defoul at least one filtration membrane in the tank. The flow path structure includes a sludge outlet proximate the bottom of the gas flow path to permit sludge in the flow path structure to fall therethrough. The chamber has a bottom that is open beneath the sludge outlet so as to permit any sludge that falls through the sludge outlet to leave the chamber. The sludge outlet is a first retentate inlet thereby permitting retentate to enter the gas flow path, so as to break bubbles present in the gas from a first size into a second size that is smaller than the first size. The at least one bottom gas inlet is positioned upstream from the barrier so as to release the gas up the first flow path portion outside of the gas release event, but is positioned proximate to the barrier bottom such that the gas that is transported into the gas flow path from the at least one bottom gas inlet during the gas release event is at least in part carried by a flow of gas and retentate in the gas flow path into and up the second flow path portion.

### BRIEF DESCRIPTION OF THE DRAWINGS

For a better understanding of the embodiment(s) described herein and to show more clearly how the embodiment(s) may be carried into effect, reference will now be made, by way of example only, to the accompanying drawings.

FIG. 1 is a sectional side view of a system for filtering a retentate including a tank and a liquid-filtration membrane module in accordance with an embodiment of the present disclosure.

FIG. 2 is a perspective sectional view of a portion of the membrane filtration system shown in FIG. 1.

FIG. 3 is a perspective view of the membrane filtration system shown in FIG. 1.

FIG. 4 is a perspective sectional view of a portion of the membrane filtration system shown in FIG. 1.

FIG. 5 is a perspective view of the membrane filtration system shown in FIG. 1, shown from underneath.

FIG. 6A is a sectional elevation view of the membrane filtration system shown in FIG. 1, shown in a first state during an operation cycle.

FIG. 6B is a sectional elevation view of the membrane filtration system shown in FIG. 1, shown in a first state during an operation cycle.

FIG. 6C is a sectional elevation view of the membrane filtration system shown in FIG. 1, shown in a third state during an operation cycle, which is a gas discharge event.

FIG. 7 is another sectional elevation view of the membrane filtration system shown in FIG. 1, showing first and second gas feed conduits.

FIG. 8 is a magnified view of a portion of the sectional elevation view shown in FIG. 6A.

FIG. 9 is a magnified sectional perspective view of a portion of a cup and a riser conduit that are included in the membrane filtration system shown in FIG. 1.

FIG. 10 is an elevation view showing a single hollow-fiber membrane to illustrate the amount of slack that is present therein.

FIG. 11 is a series of method steps in relation to a method for defouling a plurality of filtration membranes in a membrane module in accordance with another aspect of the present disclosure.

FIG. 12 is a perspective view of a pulse aeration system in accordance with another aspect of the present disclosure.

FIG. 13 is a perspective exploded view of the pulse aeration system shown in FIG. 12.

FIG. 14 is a sectional elevation view of the pulse aeration system shown in FIG. 12.

FIG. 15 is another sectional elevation view of the pulse aeration system shown in FIG. 12.

FIG. 16A is a sectional elevation view of a portion of the pulse aeration system shown in FIG. 12, showing sludge draining from a gas flow path.

FIG. 16B is a sectional elevation view of a portion of the pulse aeration system shown in FIG. 12, showing a gas release event about to start.

FIG. 16C is a sectional elevation view of a portion of the pulse aeration system shown in FIG. 12, showing retentate entering the gas flow path to break up bubbles during the gas release event.

FIG. 16D is another sectional elevation view of a portion of the pulse aeration system shown in FIG. 12, showing gas entering the gas flow path during the gas release event, to increase the amount of gas released in the gas release event.

FIG. 17 is a sectional elevation view of a portion of a pulse aeration system in accordance with another aspect of the present disclosure.

FIG. 18 is a sectional elevation view of the portion of the pulse aeration system shown in FIG. 17, during a gas release event.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

The terms “comprising” and “including” and their various conjugations (e.g. “comprises”) will be understood to be inclusive and open-ended, and not exclusive. This means that if an element A includes or comprises an element B, it will be understood that element A could include or comprise other elements in addition to including or comprising element B. The term “having” and its various conjugations are also to be understood as being open-ended in the same way as “comprising” and “including”. These terms are not to be interpreted to exclude the presence of other features, steps or components.

As used herein, the terms “about” and “approximately” are meant to cover variations that may exist in the upper and lower limits of the ranges of values, such as variations in properties, parameters, and dimensions.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns such that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

As used in this document, “attached” in describing the relationship between two connected parts includes the case in which the two connected parts are “directly attached” with the two connected parts being in contact with each other, and the case in which the connected parts are “indirectly attached” and not in contact with each other, but connected by one or more intervening other part(s) between.

As used in this document, terms describing relative positions of elements such as ‘top’, ‘upper’, ‘bottom’, ‘lower’, or other analogous terms will be understood to refer to the placement of the described element during use of the apparatus of which it is a part unless the context would make it clear that it is otherwise. It will be understood that the aforementioned placement of an element, for example, can still be considered its placement even when the object that it is a part of is lying in some position other than the position in which it will be used. As an example, if reference is made to a device having an upper member, it will be understood that the upper member is being described as having an upper position when the device that it is a part of is in use or is in position for use, unless the context would make it clear that it is otherwise. Further to this example, it will be understood that the aforementioned upper member of the object can still be considered its upper member even when the object is lying on its side, for storage, or for transport, or for some other reason.

Any method, application or module herein described may be implemented using computer readable/executable instructions that may be stored or otherwise held by a memory, and executed by a processor. Aspects of the present disclosure may be described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

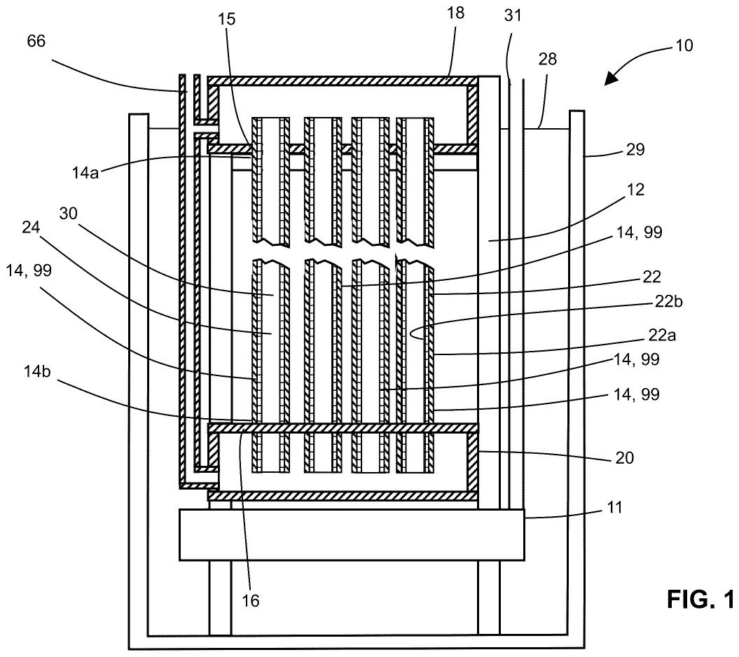

Reference is made to FIG. 1, which shows a schematic view of a liquid-filtration membrane module 10 and an aeration system 11, in accordance with an embodiment of the present disclosure. The liquid-filtration membrane module 10 includes a support structure 12 and a plurality of filtration membranes 14 which are porous. The filtration membranes 14 may be a plurality of hollow-fiber membranes shown at 99 in FIG. 1. The filtration membranes 14 may alternatively be flat sheet membranes that are held in place in any suitable way. For readability, the liquid-filtration membrane module 10 may simply be referred to as the membrane module 10. The support structure 12 may have any suitable composition, position or structure. Each of the filtration membranes 14 may be supported at a first connection point 15 in an upper header 18, at a first end 14a of the filtration membrane 14, and may be supported at a second connection point 16 in a lower header 20 at a second end 14b of the filtration membrane 14.

The filtration membranes 14 may have any suitable construction known in the art. In the case of hollow-fiber membranes, each hollow-fiber membrane 99 includes a tubular membrane wall 22 that has an exterior face 22a, and an interior face 22b that defines a lumen 24 in the hollow-fiber membrane 99. The membrane wall 22 may have any suitable construction and may be made from one or more layers of material. In the example shown, the membrane wall 22 is made from two layers of material, including a filtration layer and a structural layer, however, any other suitable construction may alternatively be provided. Only four hollow-fiber membranes 99 are shown in FIG. 1, however it will be noted that the membrane module 10 may include hundreds or thousands of such hollow-fiber membranes 99.

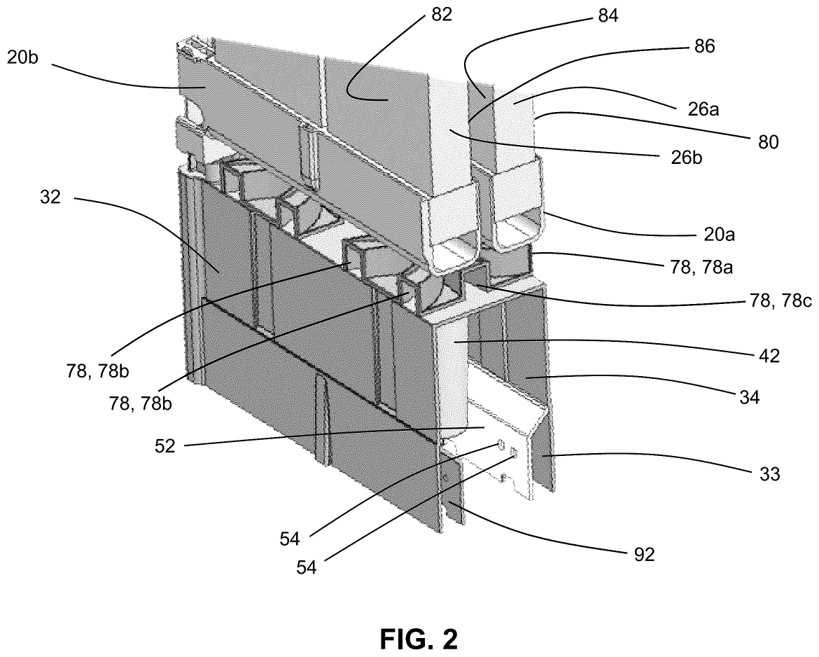

In the example embodiment shown in FIG. 2, the lower header 20 is divided into a first lower header portion 20a and a second lower header portion 20b which are spaced apart from each other laterally. The hollow-fiber membranes 99 may include a first group 26a of the hollow-fiber membranes 99 that are mounted in the first lower header portion 20a and a second group 26b of the hollow-fiber membranes 99 that are mounted in the second lower header portion 20b. The hollow-fiber membranes 99 shown in FIG. 2 are shown as simple rectangular blocks, for simplicity, however, these rectangular blocks are representative of many hollow-fiber membranes. For example, each rectangular block may represent hundreds of hollow-fiber membranes. The first and second groups 26a and 26b of the hollow-fiber membranes 99 are spaced apart by a selected gap. The upper header 18 may also include a first upper header portion and a second upper header portion (not shown), in similar manner to the second header 20. While a plurality of hollow-fiber membranes 99 are shown, it will be understood that there may be as few as one filtration membrane 14 (e.g. a hollow fiber membrane or a sheet membrane). Thus, there may be said to be at least one hollow fiber membrane 14.

While it has been shown for the membrane module 10 to include the upper header 18 and the lower header 20, it is possible for the membrane module 10 to include only a single header, which may be the upper header 18, such that the second ends of the hollow-fiber membranes 99 are sealed, or which may be the lower header 20, such that the first ends of the hollow-fiber membranes 99 are sealed.

FIG. 1 shows the membrane module 10 immersed in a tank holding a volume of a liquid to be filtered, referred to as concentrate, or retentate. Typically, the retentate is water with contaminants to be removed. The retentate is shown at 28. The tank in which the retentate 28 is filled, is shown at 29.

In operation, once the tank 29 is filled sufficiently, a pressure differential is generated across the filtration membranes 14 such that the liquid pressure in the tank 30 is greater than the pressure in the lumens 24 of the filtration membranes 14. In the case of hollow-fiber membranes, purified water permeates through the membrane walls 22 of the hollow-fiber membranes 99 into the lumens 24. The water that permeates through the filtration membranes 14 into their interiors (e.g. into the lumens 24 or channels) collects in the upper and lower headers 18 and 20 and is drawn out from the headers 18 and 20 to a collection conduit 66 where it is transported out of the tank 29 for further treatment, or for storage or use. The water that permeates through the membranes is referred to as the permeate, and is shown at 30. A portion of the collection conduit 66 is hidden from view to not obscure reference numbers and leader lines in FIG. 1. In embodiments in which there is only one header such as the upper header 18 or the lower header 20, the permeate 30 will be collected in that header 18 or 20 and is transported along the collection conduit 66 out of the tank 29 for further treatment, or for storage or use.

During operation, contaminants in the retentate 28 collect on the exterior surfaces 22a of the filtration membranes 14, which can foul the filtration membranes 14 and hinder their operation. The aeration system 11 is positioned beneath the filtration membranes 14, and is operable to release bubbles of gas, which rise and interact with the filtration membranes 14 and scour them, so as to remove the collected contamination from them, thereby permitting longer operation of the filtration membranes 14 before they need servicing. The bubbles of gas may be said to defoul the filtration membranes 14 in the tank.

The aeration system 11 in the present embodiment is a pulse aeration system, also referred to as an intermittent aeration system, which means that this aeration system releases bubbles intermittently instead of continuously. This reduces the cost of supplying gas to the aeration system, relative to a system that releases bubbles continuously.

The gas used in the aeration system 11 may be any suitable gas, and may, for example, be pressurized air. The gas is provided to the aeration system 11 from a gas source (not shown) via a gas supply conduit 31.

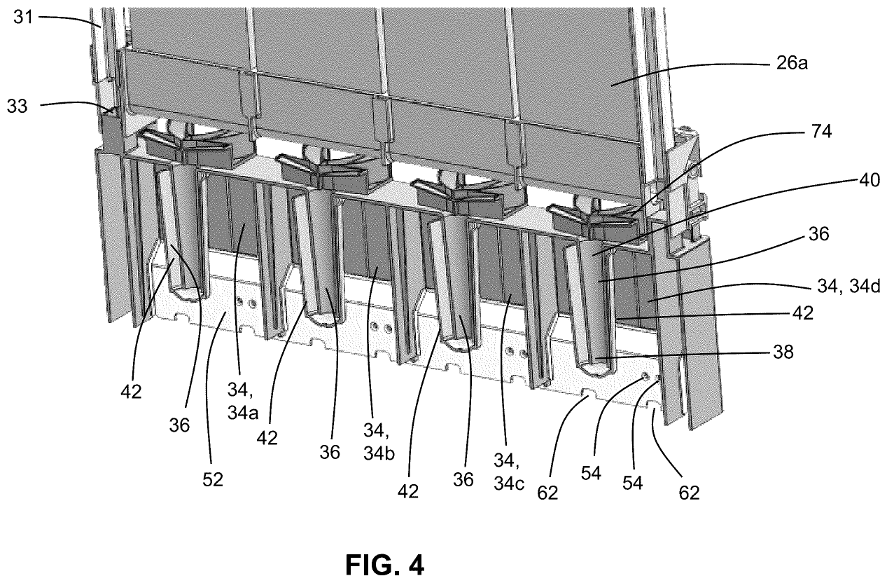

Reference is made to FIGS. 2-7. The aeration system 11 may have any suitable structure. For example, the aeration system 11 may include a chamber housing 32, and an internal gas feed conduit 33 that receives gas from the gas supply conduit 31. The chamber housing 32 defines a plurality of chambers 34 (FIG. 4). In the example shown there are four chambers 34 (shown individually at 34a, 34b, 34c, and 34d) however it will be understood that there could be any suitable number of chambers, such as two chambers 34 or more than two chambers 34. Each chamber 34 includes a riser conduit 36 having a barrier 38 positioned at a selected level in the chamber 34, so as to release gas up the riser conduit 36 when a gas level in the chamber 34 reached below the barrier 38, for release of the gas into the tank 29 so as to defoul at least one filtration membrane 14.

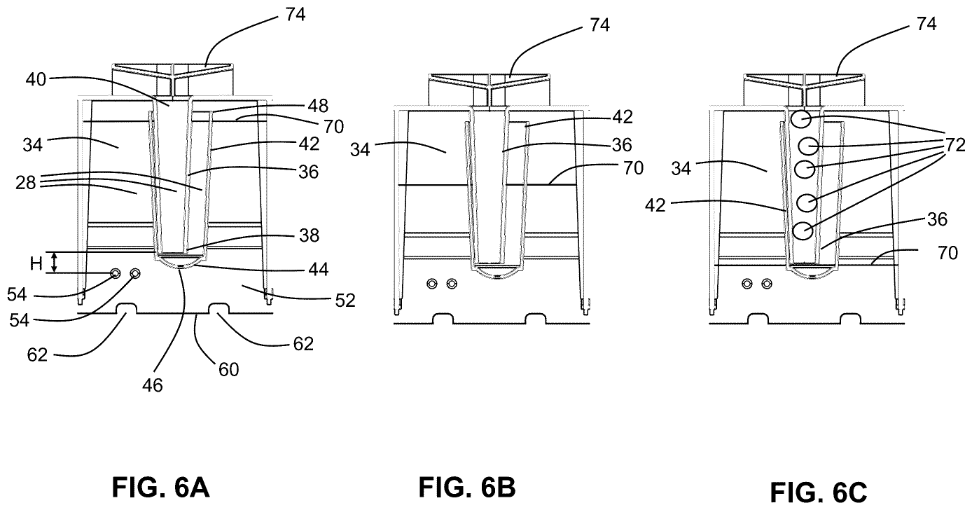

Referring to FIG. 6A, which shows a single chamber 34 from the aeration system 11, the riser conduit 36 has a riser conduit outlet 40 that is positioned to discharge air out of the chamber 34. In the embodiment shown, the riser conduit 36 is positioned inside a cup 42. The cup 42 has a bottom end 44 (also referred to as a cup bottom end 44) which has a cup aperture 46. The cup aperture 46 permits sludge that is present in the cup 42 and in the riser conduit 36 to leave the cup 42, so as to inhibit the buildup of sludge at the cup bottom end 44. The cup 42 has a top end 48 that is open and provides an inlet to the cup 42.

The cup 42 and the riser conduit 36 may together be considered an intermittent gas discharge structure. The intermittent gas discharge structure may further include other elements in addition to the cup 42 and the riser conduit 36. It is alternatively possible to provide any other suitable intermittent gas discharge structure, such as a U-shaped conduit, where the inlet end of the U-shaped conduit is positioned in the retentate 28 at a selected inlet level, and the outlet end of the U-shaped conduit is positioned to discharge gas outside of the chamber 34. A part of the U-shaped conduit where it transitions between the inlet portion and the outlet portion constitutes the barrier 38.

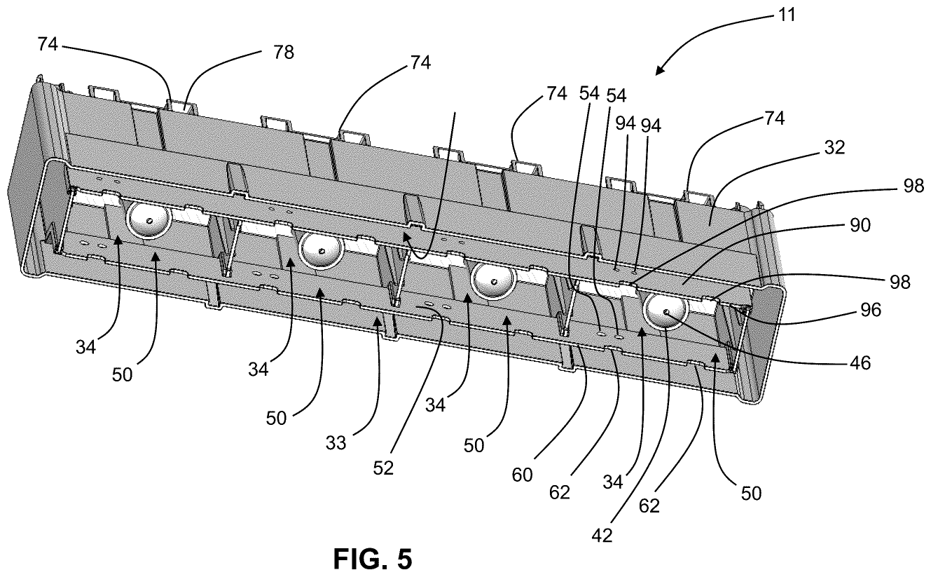

As can be seen in FIG. 5, each of the plurality of chambers 34 has a chamber bottom 50 that is open to permit retentate 28 to be present in each of the plurality of chambers 34. The chamber housing 34 may include a first wall 52 that may at least in part define the gas feed conduit 33, and which may define at least one first wall gas inlet aperture 54 into each of the plurality of chambers 34. In the embodiment shown, the at least one first wall gas inlet aperture 54 is one of a plurality of first wall gas inlet apertures 54 that are provided on the first wall 52 for each chamber 34. In the figures, there are two first wall gas inlet apertures 54 provided on the first wall 52 for the ingress of the gas into each chamber 34.

The at least one first wall gas inlet aperture 54 may be of any suitable size. For example, the at least one first wall gas inlet aperture 54 may have a cross-sectional dimension of about 1.2 cm. In embodiments in which the at least one first wall gas inlet aperture 54 is circular, the cross-sectional dimension is the diameter. It will be noted that other values for the cross-sectional dimension may be used, depending on several factors such as the size of the gas flow conduit 33. In some embodiments, the cross-sectional dimension may be bigger, or may be smaller.

In operation, gas is introduced into the chamber 34 on an optionally continuous basis via the gas feed conduit 33, through the at least one first wall gas inlet aperture 54. The gas fills the chamber 34 from the top downwards as it is less dense than the retentate 28. FIG. 6A shows the gas occupying a small region at the top of the chamber 34 after a small amount of gas has been introduced to the chamber 34. The level of the retentate 28 in the chamber 34 is shown at 70. It will be noted that the riser 36 remains full of retentate 28 during this period, even though some portion of the chamber 34 contains gas, as can be seen in FIG. 6A. As more gas is introduced via the at least one first wall gas inlet aperture 54, the level 70 of the retentate 28 lowers in the chamber 34, and in the cup 42, but the riser 36 remains filled with retentate 28, as shown in FIG. 6B. After more gas is introduced into the chamber 34, the level 70 of the retentate 28 lowers until the level 70 reaches below the bottom of the barrier 38, shown at 39 (also referred to as the barrier bottom 39). Once this occurs, a volume of gas from the cup 42 enters the riser 36, and rises up in the riser 36 to the outlet 40 of the riser 36. This volume of gas is shown at 72 in FIG. 6C, in the form of several large bubbles, however it could alternatively be in the form of a single large bubble. This volume 72 of gas will pass into a distributor shown at 74 that is positioned above the outlet 40 of the riser 36. The distributor 74 is shaped to direct the volume 72 of gas into a plurality of directions so as to discharge the volume of gas proximate the filtration membranes 14 that are positioned above distributor 74. To carry out this function, the distributor 74 has an inlet 76 and a plurality of distributor outlets 78 that are positioned to discharge the volume of gas on both sides of each of the first and second groups 26a and 26b of the filtration membranes 14. With reference to FIG. 2, in the embodiment shown, the distributor 74 has six distributor outlets 78 but could have any suitable number of distributor outlets 78, including two (or more broadly, a plurality of) first distributor outlets 78a positioned on a first side 80 of the first group 26a of filtration membranes 14, two (or more broadly, a plurality of) second distributor outlets 78b positioned on a first side 82 of the second group 26b of filtration membranes 14, and two (or more broadly, a plurality of) third distributor outlets 78c positioned in a space between the first and second groups 26a and 26b of filtration membranes 14 so as to discharge gas on a second side 84 of the first group 26a of filtration membranes 14 and on a second side 86 of the second group 26b of filtration membranes 14. However, the distributor 74 may have any other suitable number of outlets 78.

In the embodiment shown, the distributor 74 has a distributor conduit 87 that leads to each distributor outlet 78. In the embodiment shown, each distributor 74 has six distributor conduits 87. However, it will be noted that the distributor 74 could at least theoretically include a simple box shape with six distributor outlets (i.e. apertures in the wall of the box), without necessarily having individual conduits leading to each distributor outlet.

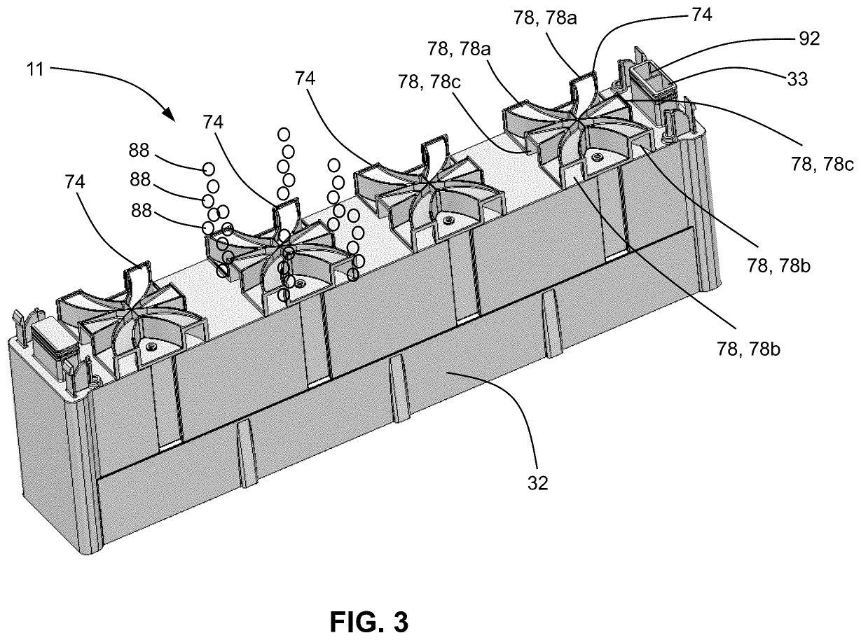

Furthermore, the distributor outlets 78 of the distributor 74 are sized to release bubbles shown at 88 in FIG. 3 that are of a selected size, so as to provide good performance at cleaning the exterior faces of the filtration membranes 14 (i.e. the exterior faces 22a of the tubular membrane walls 22 of the hollow-fiber membranes or the exterior faces of the walls of the flat sheet membranes). Bubbles 88 are shown only being discharged from a single distributor 74 in FIG. 3, however it will be understood that bubbles 88 will be discharged from each distributor 74 during a gas discharge event as illustrated in FIG. 6C.

While the volume 72 of gas is being discharged, the level 70 of the retentate 28 rises in the chamber 34 until it reaches the top 48 of the cup 42, at which point retentate 28 enters the cup 42, bringing the level 70 of the retentate 28 in the cup 42 to reach above the barrier bottom 39. As a result, no further gas is discharged, and the gas and the retentate 28 find an equilibrium level in the chamber 34 and in the cup 42. The riser 36 is at this point completely filled with retentate 28, and the chamber 34 appears as shown in FIG. 6A once more. At this point the chamber 34 begins once more filling with gas.

In some embodiments, the at least one first wall gas inlet aperture 54 is positioned at an elevation that is within 3 cm of the barrier bottom 39, as represented by height difference H in FIG. 6A (i.e., the center of the at least one first wall gas inlet aperture 54 is positioned at an elevation that less than or equal to 3 cm below the barrier bottom 39 and is less than or equal to 3 cm above the barrier bottom 39. An advantage of this positioning of the at least one first wall gas inlet aperture 54 is described below.

As a result of this arrangement, the at least one first wall gas inlet aperture 54 is submerged in the retentate 28 during a majority of the operation cycle where the chamber 34 is being filled with gas, such that the at least one first wall gas inlet aperture 54 remains wetted for most of the operation cycle, thereby inhibiting the adhering of contaminants at the at least one first wall gas inlet aperture 54. During the gas discharge event shown in FIG. 6C however, the at least one first wall gas inlet aperture 54 is then exposed to gas briefly during the gas discharge event as the retentate level is briefly below the barrier bottom 39. The at least one first wall gas inlet aperture 54 is then exposed to rushing liquid during the gas discharge event, which then helps to remove any contaminants that may have adhered to the at least one first wall gas inlet aperture 54, thereby inhibiting the contaminants from occluding the at least one first wall gas inlet aperture 54. It has been found in testing that the at least one upper first wall gas inlet aperture 54 remains unoccluded even operating with retentate 28 that has a particulate contaminant concentration as high as 25 g/l.

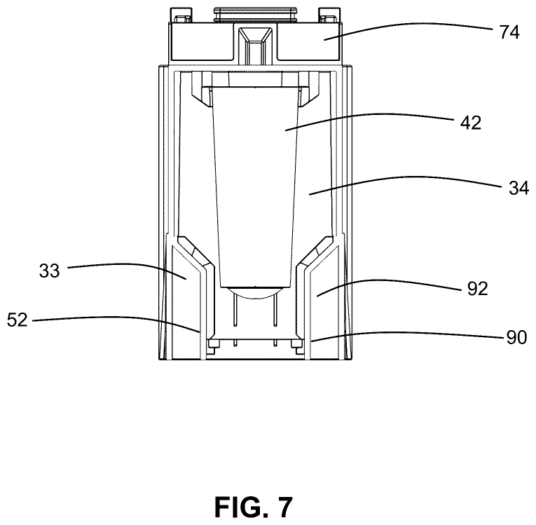

Referring to FIGS. 6A and 7, it will be noted that the gas feed conduit 33 has a selected cross-sectional area (shown best in FIG. 7, which is a view of the gas feed conduit 33 perpendicular to the direction of flow of the gas). In the embodiment shown, a ratio R of the cross-sectional area of the gas feed conduit to the total cross-sectional area for the at least one first wall gas inlet aperture 54 is greater than a selected value, such that a gas pressure at each one of the at least one first wall gas inlet apertures 54 for all of the plurality of chambers 34 differs from one another by less than 5 percent. By keeping the difference in the gas pressure at each one of the at least one first wall gas inlet apertures 54 for all of the plurality of chambers 34 so consistent, the distribution of the bubbles 88 from the distributors 74 of all the chambers 34 is relatively consistent, thereby inhibiting the fouling of some filtration membranes 14 while other filtration membranes 14 remain unfouled. The particular minimum value for the ratio R of the aforementioned cross-sectional areas will vary depending on the particular geometry of the gas feed conduit 33.

The first gas flow conduit 54 may have any suitable size. For example, in the embodiment shown, the second gas flow conduit 54 may have a width of about 2.25 cm and a height at its peak of about 8.5 cm. The angled portion of the first wall 52 may be angled at about 45 degrees relative to the wall of the chamber housing 32. Any other suitable dimensions may be used.

It will be noted that the cross-sectional area of the portion of the gas feed conduit 33 that extends along the first wall gas inlet apertures 54 for all of the plurality of chambers 34 has a substantially constant cross-sectional area along its length, with the only variations in cross-sectional area being due to small deformations formed to act as stiffening ribs on the chamber housing 34.

Additionally, in some embodiments, the at least one first wall gas inlet aperture 54 may be referred to as at least one upper first wall gas inlet aperture 54, and is spaced from a bottom (shown at 60) of the first wall 52. The first wall 52 may further define at least one lower first wall gas inlet aperture 62 that is positioned at the bottom 60 of the first wall 52. The at least one lower first wall gas inlet aperture 62 may be a plurality of lower first wall gas inlet apertures 62, as shown in FIG. 6A. Advantageously, each of the at least one lower first wall gas inlet aperture 62 is larger in cross-sectional area than the cross-sectional area for each of the at least one upper first wall gas inlet aperture 54. The at least one lower first wall gas inlet aperture 62 can permit some gas flow into the chambers 34 in the event that the at least one upper first wall gas inlet aperture 54 becomes occluded. While the larger cross-sectional area of the at least one lower first wall gas inlet aperture 62 as compared to the cross-sectional area of the at least one upper first wall gas inlet aperture 54 may result in some variation in the gas pressure along the length of the gas feed conduit 33, it also helps to inhibit occluding of the at least one lower first wall gas inlet aperture 62, so that the aeration system 11 remains functional until a convenient time that the membrane filtration system 10 can be stopped for maintenance.

In some embodiments, the gas feed conduit 33 is a first gas feed conduit, and the chamber housing 34 may further include a second wall 90 that may at least in part define a second gas feed conduit 92, and which may define at least one second wall gas inlet aperture 94 into each of the plurality of chambers 34. In the embodiment shown, the at least one second wall gas inlet aperture 94 is one of a plurality of second wall gas inlet apertures 94 that are provided on the second wall 90 for each chamber 34. In the figures, there are two second wall gas inlet apertures 94 provided on the second wall 90 for the ingress of the gas into each chamber 34.

The second gas flow conduit 90 may have any suitable size, and may be sized similarly to the first gas flow conduit 33.

The at least one second wall gas inlet aperture 94 may be of any suitable size, and may be sized similarly to the at least one first wall gas inlet aperture 54.

In similar manner, and to similar advantage as the at least one first wall gas inlet aperture 54, the at least one second wall gas inlet aperture 94 may be positioned at an elevation that is within 3 cm of the barrier bottom 39.

Additionally, as shown in FIG. 5, in some embodiments, the at least one second wall gas inlet aperture 94 may be referred to as at least one upper second wall gas inlet aperture 94, and is spaced from a bottom (shown at 96) of the second wall 90. The second wall 90 may further define at least one lower second wall gas inlet aperture 98 that is positioned at the bottom 96 of the second wall 90. The at least one lower second wall gas inlet aperture 98 may be a plurality of lower second wall gas inlet apertures 98.

The chamber housing 34 may include a second wall 60 defining at least one second wall gas inlet aperture 62 into each of the plurality of chambers 34. In the embodiment shown, the at least one second wall gas inlet aperture 62 is one of a plurality of second wall gas inlet apertures 62 that are provided on the second wall 62 for each chamber 34. In the figures, there are two second wall gas inlet apertures 62 provided on the second wall 60 for the ingress of the gas into each chamber 34.

As can be seen in FIG. 5, it will be noted that the first and second gas feed conduits 33 and 92 each have a bottom end that is open to permit retentate 28 to be present in each of the first and second gas feed conduits 33 and 92.

As can be seen in FIG. 4, it is optionally possible to position the cup 42 and the riser conduit 36 such that the riser conduit 36 is nonconcentric in the cup 42, and is adjacent the interior wall of the cup 42. It has been found that the overall pressure drop is reduced in the space between the cup 42 and the riser conduit 36 so as to facilitate fluid flow in that space. In the embodiment shown, the riser conduits 36 are positioned forwardly in the cups 42, where forwardly refers to the direction of flow of the gas in the gas feed conduits 33 and 92.

As can also be seen in FIG. 4, the at least one first wall gas inlet aperture 54 is positioned in a downstream portion of each chamber 34. It has been found that this positioning improves the consistency of the gas pressure at each of the at least one upper first wall gas inlet aperture 54.

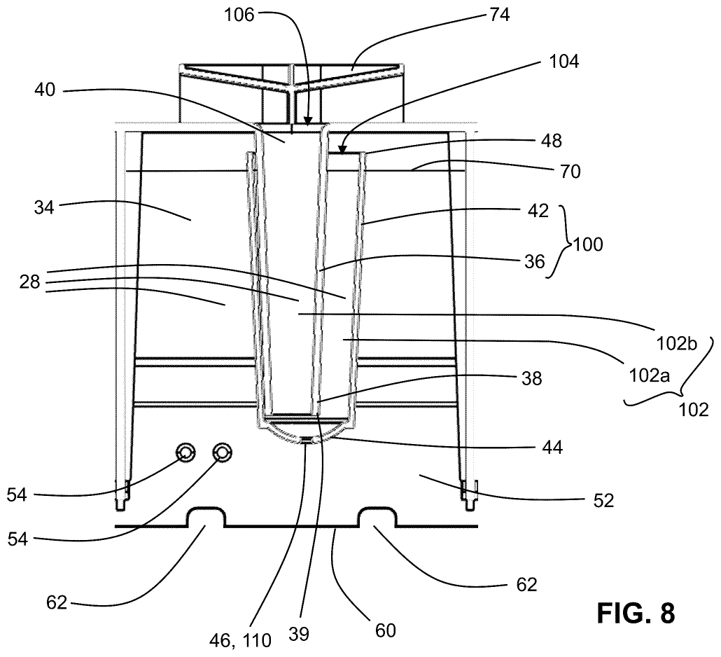

Referring to FIG. 8, which is a magnified view of FIG. 6A. The structure shown in FIG. 8 may be described as follows. The cup 42 and the riser conduit 36 may together be referred to as a flow path structure 100 that defines a flow path 102 having a flow path inlet 104 and a flow path outlet 106. The flow path inlet 104 in the embodiment shown is at the top of the cup 42. The flow path outlet 106 is at the top of the riser conduit 36. The flow path 102 including a first flow path portion 102a that extends downwardly downstream from the flow path inlet 104, and a second flow path portion 102b that extends upwardly upstream from the flow path outlet 106 and downstream from the first flow path portion 102a. The barrier 38 is defined by the flow path structure 100. In the embodiment shown, it is defined specifically by the riser conduit 36. The barrier bottom 39 is positioned at a selected level in the chamber 34 so as to permit a release event during which some gas (i.e. the volume of gas 72) is released up the second flow path portion 102b from the first flow path portion 102a when a gas level of the gas in the flow path 102 reaches below the barrier bottom 39.

The flow path outlet 106 is positioned for release of the gas (i.e. the volume of gas 72) into the tank 29 (FIG. 1) so as to defoul a plurality of filtration membranes 14 in the tank 29.

As was noted above in relation to the intermittent gas discharge structure, the flow path structure 100 has been shown as having been formed by the cup 42 and the riser conduit 36, but could alternatively be formed from any suitable structure, such as by a generally U-shaped conduit which includes a flow path inlet on one side of the U-shape, a flow path outlet on the other side of the U-shape, and a barrier with a barrier bottom that is a point at the bottom of the U-shaped conduit where the U-shaped conduit stops extending downwardly and starts extending upwardly.

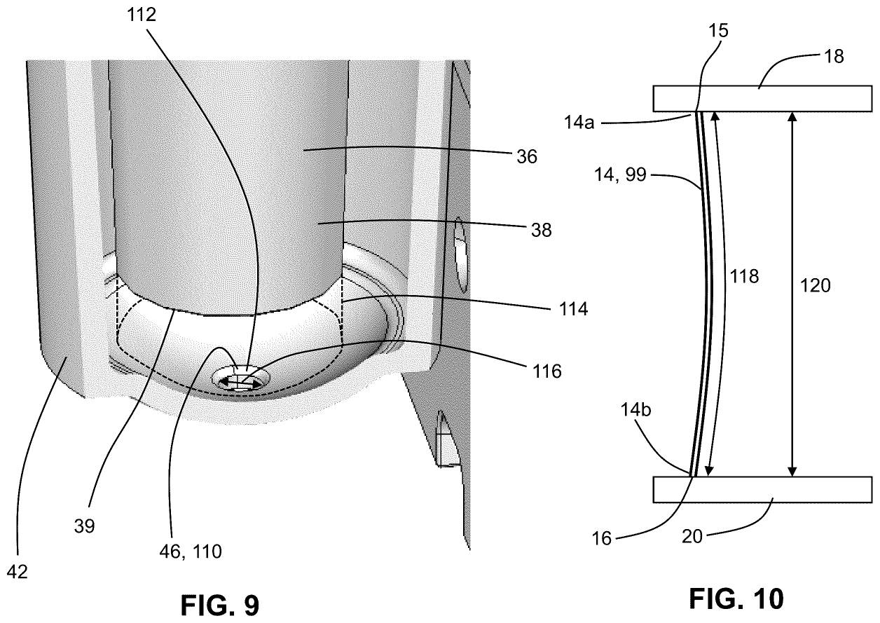

Reference is made to FIG. 9, which is a magnified perspective sectional view of the cup 42, illustrating the cup aperture 46 and the flow path 102 at the barrier bottom 39. The cup aperture may, more broadly, be referred to as the flow path aperture 110, since the flow path may be formed by any suitable structure and therefore need not be formed by a cup and a riser conduit. The flow path aperture 110 may be positioned proximate a bottom (shown at 112) of the flow path 102. As can be best seen in FIG. 8, in the example embodiment shown, the flow path aperture 110 is positioned precisely at the bottom 112 of the flow path 102. However, the flow path aperture 110 need not be positioned precisely at the bottom 112 of the flow path 102. It is at least theoretically possible for the flow path aperture 110 to be positioned near the bottom 112 without being precisely at the bottom 112. In such an embodiment, it is theorized that more sludge may build up in the flow path structure 100 than in an embodiment in which the flow path aperture 110 is precisely at the bottom 112. A small amount of sludge buildup may be permissible in some embodiments. For greater certainty, in the present disclosure, it will be noted that “proximate” is intended to encompass “near to” and also “precisely positioned at”. Thus, “proximate the bottom” encompasses “near to the bottom” and also “precisely positioned at the bottom”.

The area of the flow path aperture 110 may be a selected area, in relation to the area of the flow path at the barrier bottom 39. More specifically, the area of the flow path may be between 2% and 12% of the area of the flow path 110 at the barrier bottom 39.

In the embodiment shown, the area of the flow path 110 at the barrier bottom 39 is a generally cylindrical shape shown in dashed lines between the barrier bottom 39 and the bottom of the cup 42, and identified with reference number 114. In other embodiments, such as where the flow path is formed by a U-shaped conduit, the area of the flow path at the barrier bottom would be formed across a cross-section of the U-shaped conduit.

By providing the above noted relationship of the area of the flow path aperture 110 and the area of the flow path 102 at the barrier bottom, it has been found that several advantages are provided simultaneously. One advantage is that the flow path aperture 110 is sufficiently large to facilitate the removal of sludge from the bottom of the flow path structure 100, and is also sufficiently large to inhibit clogging from the sludge during operation. A second advantage is that the flow path aperture 110 is sufficiently small that each of the magnitude of successive ones of the gas release events, the frequency of the gas release events, and the period between subsequent gas release events is non-random. More specifically, the area of the flow path aperture 110 relative to the area of the of the flow path 102 at the barrier bottom 39 affects whether each of a magnitude of successive ones of the gas release events, a frequency of the gas release events, and the period between gas release events is random or not. By keeping the relative areas within the selected range noted above, the applicant has found that each of the magnitude of successive ones of the gas release events, the frequency of the gas release events, and the period is not random. In some embodiments, “non-random” (and accordingly, “consistent”) may mean that the variation in each of the magnitude of successive ones of the gas release events, the frequency of the gas release events, and the periods between successive gas release events is less than a selected value such as 10%. In some embodiments, “non-random” may mean that the variation in each of the magnitude of successive ones of the gas release events, the frequency of the gas release events, and the periods between successive gas release events is less than a selected value such as 5%.

In some embodiments, a cross-dimension of the flow path aperture 110 may be in the range of 3 mm to 8 mm. The cross-dimension for the flow path aperture 110 shown in FIG. 9 is shown at 116. In the example shown, in which the flow path aperture 110 is circular, the cross dimension will be consistent in any direction. In other embodiments, the flow path aperture may have another shape such that the cross-dimension along one axis may be different than the cross-dimension along another axis. In such a case, the cross-dimension may be considered to be the smallest value for the distance across the cross-section of the flow path aperture 110 of all the possible cross-dimensions across it. By providing a cross-dimension of 3 mm to 8 mm the flow path aperture 110 is theorized to be sufficiently resistant to clogging from sludge buildup over time. The flow path aperture 46 may thus be said to be sized to permit sludge in the flow path 102 to pass therethrough to exit the flow path 102. The flow path aperture 110 may be referred to as a sludge outlet, due to its role in removing sludge from the flow path 102.

It will be noted that other alternative shapes for the flow path aperture 110 any other any suitable shape such as an elliptical shape, a regular or irregular polygonal shape or a generally irregular shape that may include a plurality of arcuate sidewalls and/or a plurality of planar sidewalls.

In some embodiments, the filtration membranes 14 are arranged proximate to one another so as to achieve a high space efficiency, as shown at least schematically in FIG. 1. The specific density of the arrangement of the filtration membranes 14 may be selected based on any suitable criteria such as, for example, the material that is being filtered out of the retentate 28 or the concentration of the material that is present in the retentate 28 to be filtered. With reference to FIG. 10, which shows an example of a single hollow-fiber membrane 99, the hollow-fiber membranes 99 may be mounted to permit at least a selected amount of lateral movement during operation. To achieve the selected amount of lateral movement, the hollow-fiber membranes 99 may have at least 2% slack. 2% slack means that the length of the hollow-fiber membranes 99 (shown at 118) in the space between the first and second headers 18 and 20, is at least 2% longer than the distance (shown at 120) between the first and second headers 18 and 20.

In some embodiments, the amount of slack in the hollow-fiber membranes 99 may be less than a selected value such as 30%.

It will be noted that the figures are not necessarily to scale, and so the amount of slack that is present in the hollow-fiber membrane 99 shown in FIG. 10 may be exaggerated in order to better illustrate the slack.

By providing at least 2% slack, the hollow-fiber membranes 99 are better able to move in the retentate 28 and to be cleaned of any buildup that occurs on their exterior faces 22a.

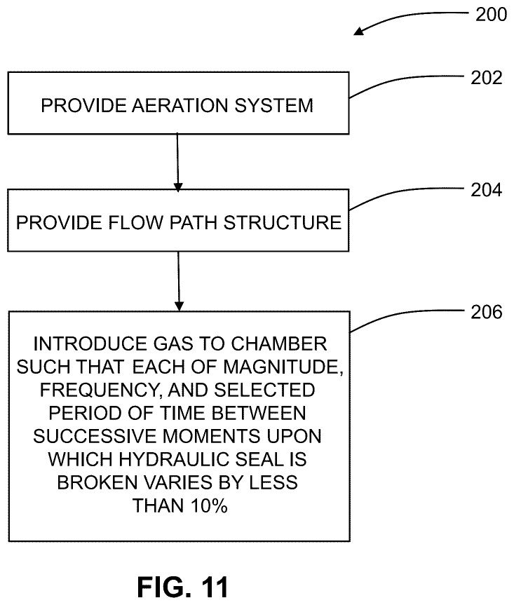

Reference is made to FIG. 11, which illustrates a method 200 for defouling a plurality of filtration membranes 14 (e.g. the hollow-fiber membranes 99 or the flat sheet membranes) in a membrane module (e.g. the membrane module 10) that is immersed in a tank (e.g. the tank 29) that contains a retentate (e.g. the retentate 28). The method 200 includes a step 202 which includes providing an aeration system containing a chamber 34 that contains the retentate 28. The method 200 further includes a step 204 which includes providing a flow path structure 100 defining a flow path 102 having a flow path inlet 104 and a flow path outlet 106, the flow path structure 100 including a barrier 38 having a barrier bottom 39, and a flow path aperture 46 positioned along the flow path 102 between the flow path inlet 104 and the flow path outlet 106.

The method 200 further includes introducing gas into the chamber 34 so as to lower the level 70 of the retentate 28 in the chamber, such that, after a selected period of time, the gas lowers the level 70 of the retentate 38 to break a hydraulic seal at the barrier bottom 39, and thereby release some of the gas past the barrier bottom 39 to exit the flow path outlet 106, in such a way that the gas passes along the plurality of filtration membranes so as to defoul the plurality of filtration membranes.

According to the method 200, each of the magnitude of successive ones of the gas release events, the frequency of the gas release events, and the selected period of time between successive moments upon which the hydraulic seal is broken varies by less than 10% (and is therefore considered to be non-random in accordance with the definition of non-random provided herein). In some embodiments, each of the magnitude of successive ones of the gas release events, the frequency of the gas release events, and the selected period of time between successive moments upon which the hydraulic seal is broken varies by less than 5% (and is therefore considered to be non-random in accordance with the definition of non-random provided herein).

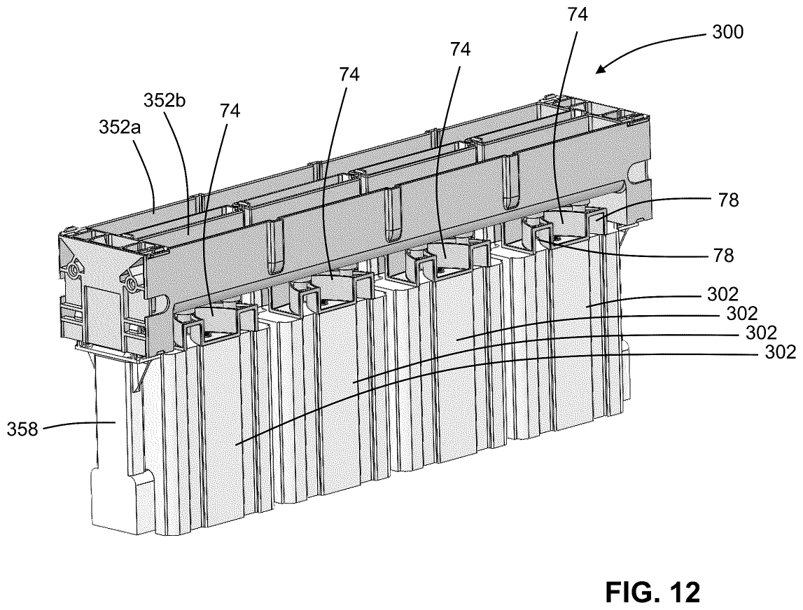

Reference is made to FIG. 12-16D which shows a pulse aeration system 300 in accordance with another embodiment of the present disclosure. The pulse aeration system 300 may be mounted in a tank (e.g. the tank 29 shown in FIG. 1) for use with an immersed filtration system (e.g., with the membrane module 10 shown in FIG. 1 or with any other membrane system containing at least one membrane).

The pulse aeration system 300 includes a single chamber housing 302 that defines a single chamber 304. Optionally, the pulse aeration system 300 includes a plurality of chamber housings 302 that each define a single chamber 304, as shown in FIG. 12. In an alternative embodiment, the chamber housing 302 may be elongate and may define a plurality of chambers, similar to the chamber housing 32. The chamber 304 has a flow path structure 306 that defines a gas flow path 308 having at least one gas inlet 310 and a flow path outlet 312. The gas flow path 308 includes a first flow path portion 314 that extends downward downstream from a first end thereof (shown at 316), and a second flow path portion 318 that extends upwardly upstream from the flow path outlet 312 and downstream from the first flow path portion 314.

The at least one gas inlet 310 may be positioned anywhere suitable. In the embodiment shown in FIGS. 12-16D, the at least one gas inlet 310 includes at least one bottom gas inlet 310a, which is positioned proximate a bottom 319 of the gas flow path 308 and is directly fluidically connected to a gas feed conduit 320 for transporting a gas into the gas flow path 308 from a gas source (not shown). The gas source may be any suitable type of gas source such as a fan, a compressor, an accumulator, or any other suitable type of gas storage vessel, or any other suitable type of gas source.

The flow path structure 306 defines a barrier 321 that is fluidically between the first and second flow path portions 314 and 318. The barrier 321 has a barrier bottom 322 that is positioned at a selected level in the chamber 304 so as to permit a gas release event during which gas that is present in the gas flow path 308, gas that is present in the chamber 304 outside of the gas flow path 308 (e.g. at the top of the chamber 304), and, in some embodiments, gas that is stored in the gas feed conduit 320 and gas that continues to be fed into the gas feed conduit 320 from the gas source, are all released up the second flow path portion 318 from the first flow path portion 314 when a gas level of the gas in the flow path reaches below the barrier bottom 322. The flow path outlet 312 is positioned for release of the gas into the tank 29 so as to defoul at least one filtration membrane 14 in the tank 29.

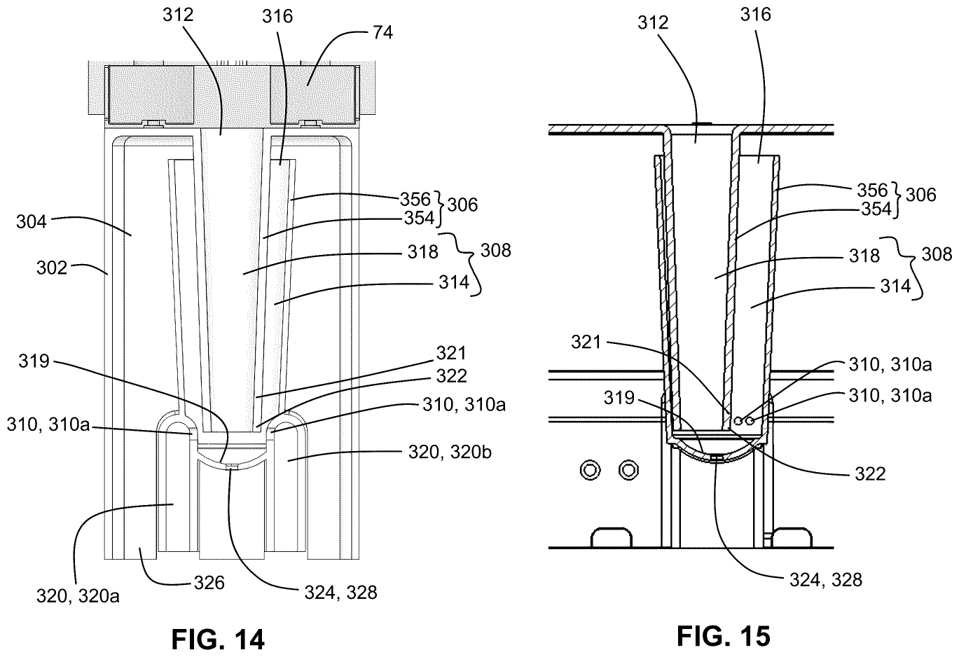

Similar to the embodiment shown in FIGS. 6A-10, the flow path structure 306 (FIG. 14) optionally includes a flow path aperture that may be referred to as a sludge outlet 324 proximate the bottom 319 of the gas flow path 308 to permit sludge in the flow path structure 306 to fall therethrough during use of the pulse aeration system 300.

A gas release event for the pulse aeration system 300 may be triggered in similar fashion to the gas release event represented in FIGS. 6A-6C. The gas that enters into the chamber 304 drives the level 70 of the retentate 28 downward progressively until the level 70 of the retentate 28 drops to below the barrier bottom 322, at which point the gas is released up the second flow path portion 318.

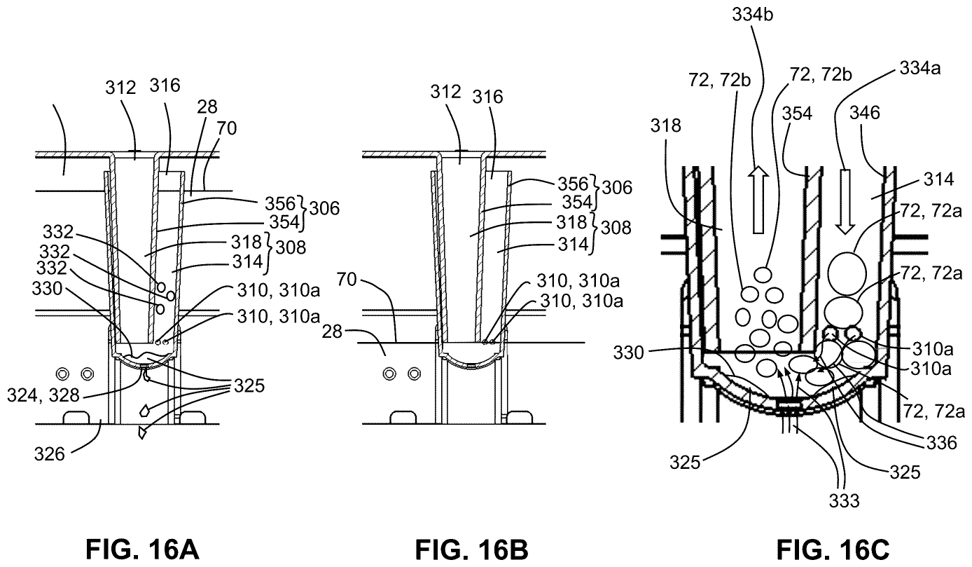

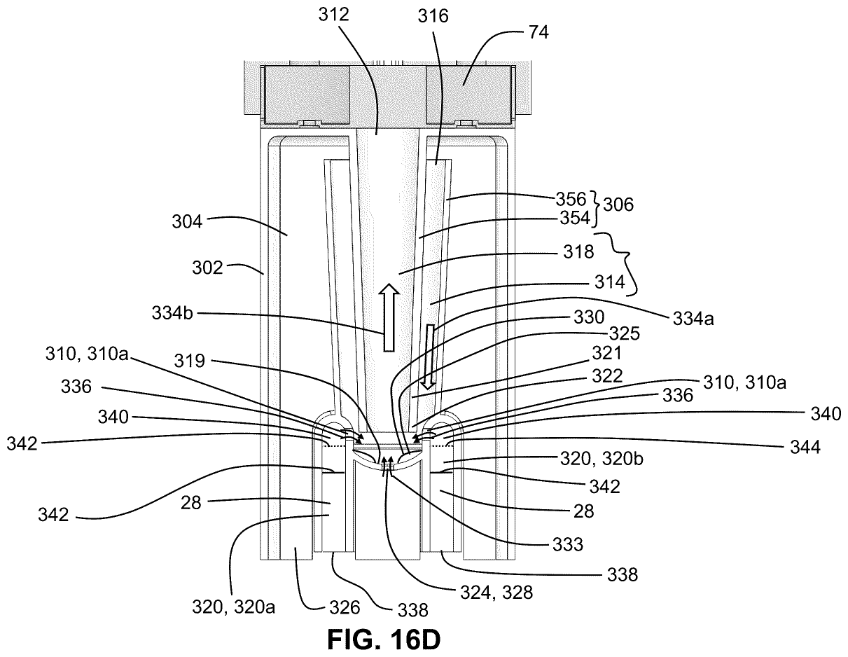

The sludge outlet 324 performs at least two functions. Firstly, the presence of the sludge outlet 324 permits the drainage of sludge (shown at 325) from the gas flow path 308. This is represented in FIG. 16A. It will be noted that the chamber 204 has a bottom 326 that is open beneath the sludge outlet 324 so as to permit any sludge 325 that falls through the sludge outlet 324 to leave the chamber 304.

The second function of the sludge outlet 324 relates to the operation of the pulse aeration system 300 during a gas release event. FIG. 16B shows the moment that the level 70 of the retentate 28 is low enough to trigger the gas release event. During the gas release event (FIGS. 16C and 16D), retentate 28 is pushed up through the sludge outlet 324 (represented by arrows 333) into the gas flow path 308 due to a reduction in pressure in the gas flow path 308 from the release of the gas. As the retentate 28 enters the gas flow path 308 in a controlled manner, the retentate 28 interacts with the gas by breaking up bubbles 72 of the gas from bubbles 72a of a first size into smaller bubbles (i.e. bubbles of a second size 72b that are smaller than the bubbles 72a of the first size), as represented in FIG. 16C. Thus, the sludge outlet 324 may also be referred to as a first retentate inlet 328. In addition to breaking up the bubbles 72, 72a, the controlled entry of the retentate 28 into the gas flow path 308 through the first retentate inlet 328 also helps to break up some of the sludge 325 that may have hardened into a layer (shown at 330) on the bottom 319 of the gas flow path 308, as illustrated by the relative sizes of the layer 330 in FIG. 16B and FIG. 16C.

The flow through the flow path outlet 312 is primarily gas flow during a gas release event, with selected and controlled bubble sizes with repeatable cycles, and as such is not considered or intended to be a two-phase flow.

A benefit of the positioning of the at least one bottom gas inlet 310a is described below. As can be seen in FIG. 15 in particular, the at least one bottom gas inlet 310A is positioned upstream from the barrier bottom 322 so as to release the gas up the first flow path portion 314 outside of the gas release event (as can be seen in FIG. 16A by bubbles 332 which are released from the at least one bottom gas inlet 310a into the first flow path portion 314). FIGS. 16C and 16D as noted above illustrate a gas release event. FIG. 16C is a sectional view of the gas flow path in one plane (a side elevation view) and FIG. 16D is a sectional view of the gas flow path in an orthogonal plane (an end elevation view), which shows the gas feed conduits 320. It will be noted that FIG. 16D omits the bubbles that are shown in FIG. 16C so as not to obscure other elements that are shown. During a gas release event, there is a flow of gas and retentate 28 from the first flow path portion 314 into the second flow path portion 318 and upwards towards the flow path outlet 312, as represented by arrows 334a and 334b. It will be noted that the at least one bottom gas inlet 310a continues to be fed gas from the gas source, and thus continues to release gas (represented by arrows 336) into the gas flow path 308 during the gas release event. The at least one bottom gas inlet 310a is positioned proximate to the barrier bottom 322 such that the gas that is transported into the gas flow path 308 from the at least one bottom gas inlet 310a during the gas release event is at least in part carried by the flow of gas and retentate 28 in the gas flow path 308 into and up the second flow path portion 318. Thus an additional amount of gas is released in the gas release event than would be released if the gas were simply released through an outlet within the chamber 304 itself.

Furthermore, the at least one bottom gas inlet 310a may in some embodiments provide another advantage. As can be seen in FIG. 16D, the bottoms of the gas feed conduits 320 (shown at 338) are open, and as a result some retentate 28 is present in the gas feed conduits 320. Due to the pressure of the gas in the gas feed conduits 320, there is also a volume of gas in the gas feed conduits 320 (shown at 340). The gas and retentate are at equilibrium prior to the gas release event. The level of the retentate 28 in the gas feed conduits 320 is shown at 342. During a gas release event, as the pressure in the gas flow path 308 reduces, there is a pressure imbalance between the retentate 28 in the gas feed conduits 320 and the volume of gas 340 in the gas feed conduits 320, which drives the gas from the volume of gas 340 out through the at least one bottom gas inlet 310a into the gas flow path 308, beyond the flow rate of gas that is entering the gas feed conduits 320 from the gas source, until eventually a new equilibrium is reached between the pressure of the gas flowing into the gas feed conduits 320 from the gas source and the level of the retentate in the gas feed conduits 320 (shown by dashed line 344). Worded another way, it may be said that a flow of gas through the flow path outlet 312 during the gas release event reduces pressure in the gas flow path 208, which in turn generates a pressure imbalance in the gas feed conduits 320 between the retentate therein and the volume of gas 340 therein, which in turn drives at least a portion of the volume of gas 340 out through the at least one gas inlet 310a into the gas flow path 308. The accelerated burst of gas entering the gas flow path 308 resulting from the pressure imbalance further enhances the breakup of sludge 325 that may be present near the bottom 319 of the gas flow path, so as to facilitate the drainage of the sludge 325 through the sludge outlet 324. Additionally, other types of debris may be present in the retentate including, for example, leaves, which can partially occlude apertures such as the at least one bottom gas inlet 310a and the sludge outlet 324. The accelerated burst of gas may help to dislodge such debris in instances the gas flow along that is attributable to the gas flow into the gas feed conduits 320 alone might not be sufficient to dislodge such debris. Once the gas release event has finished and a hydraulic seal is returned to the second flow path portion 318, the gas pressure in the gas feed conduits 320 increases thereby returning the level of the retentate to the level shown at 342.

In the embodiment shown in FIGS. 14 and 15, the at least one gas inlet 310 may be a plurality of gas inlets 310. For example, the plurality of gas inlets 310 may be arranged such that there are two gas inlets 310 which transport gas from a first gas feed conduit 320 (shown specifically at 320a) into the gas flow path 308, and two other gas inlets 310 (only one of which is shown in the sectional view in FIG. 14) which transport gas from a second gas feed conduit 320 (shown specifically at 320b) into the gas flow path 308. The first and second gas feed conduits 320a and 320b receive gas from a gas source (not shown) via a plurality of further gas feed conduits such as the vertical conduit shown at 350 which feeds the first and second gas feed conduits 320a and 320b, and the horizontal conduits shown at 352a and 352b, which feed the vertical conduit 350. In such embodiments as shown in FIGS. 14 and 15, the gas flow path 308 may be referred to as a multi-inlet gas flow path, though it is contemplated that there may be as few as one gas inlet 310, in which case the gas flow path 308 would not be referred to as a multi-inlet gas flow path.

The flow path structure 306 may be configured to define the gas flow path 308 in any suitable way. For example, the flow path structure 306 may include a riser conduit 354 that defines the second flow path portion 318 and the barrier 320, and a cup 356 that surrounds the riser conduit 354 so as to define the first flow path portion 314 and the at least one gas inlet 310. In this embodiment, the sludge outlet 324 is at a bottom of the cup 356, which is the bottom 319 of the gas flow path 308.

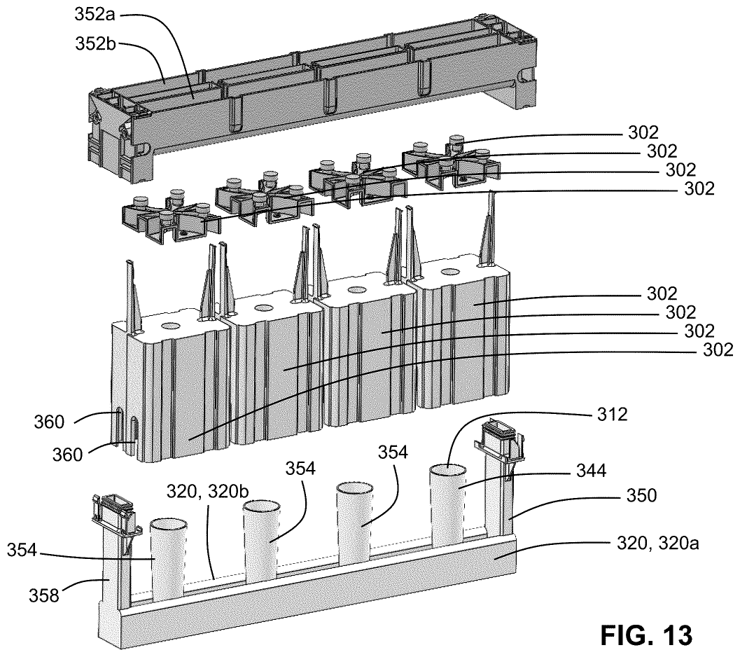

The first and second gas feed conduits 320a and 320b may be integrally formed with the riser conduits 354 as can be seen in the exploded view in FIG. 13. The vertical conduit 350, and optionally another vertical conduit shown at 358 may also be integrally formed with the first and second gas feed conduits 320a and 320b.

The first and second gas feed conduits 320a and 320b may be received in cutouts 360 in the chamber housings 302. The first and second horizontal conduits 342a and 342b may be integrally formed with one another, and may clip to the vertical conduits 350 and 358.

Referring to FIGS. 12 and 13, a distributor 74 as shown in FIGS. 2-8, may be positioned on top of the flow path outlet 312 for each chamber 304. The distributor 74, as described above in relation to FIGS. 2-8 includes a plurality of distributor outlets 78 that are oriented so as to distribute gas leaving the flow path outlet 312 in a plurality of directions, so as to distribute the gas to a first side of the at least one filtration membrane (e.g. at least one hollow-fiber membrane 14) and to a second side of the at least one filtration membrane.

While it has been described for the sludge outlet 110 to be sized to seal the second flow path portion 102b within a selected range of time after the gas release event begins, and that the area of the sludge outlet 110 is selected so as to prevent more than a 10% variation in each of the magnitude of successive ones of the gas release events, the frequency of the gas release events, and the periods between successive ones of the gas release events, similarly, the first retentate inlet 328 may optionally be sized to seal the second flow path portion 314 within a selected range of time after the gas release event begins, and the area of the first retentate inlet 328 and the area of the at least one second retentate inlet 410 may optionally be selected so as to prevent more than a 10% variation in each of the magnitude of successive ones of the gas release events, the frequency of the gas release events, and the periods between successive ones of the gas release events.

Worded another way, the first retentate inlet 328 may be sized to seal the second flow path portion 314 within a selected range of time after the gas release event begins, such that the pulse aeration system 400 delivers gas bubbles with repeatable cycles that are not random.

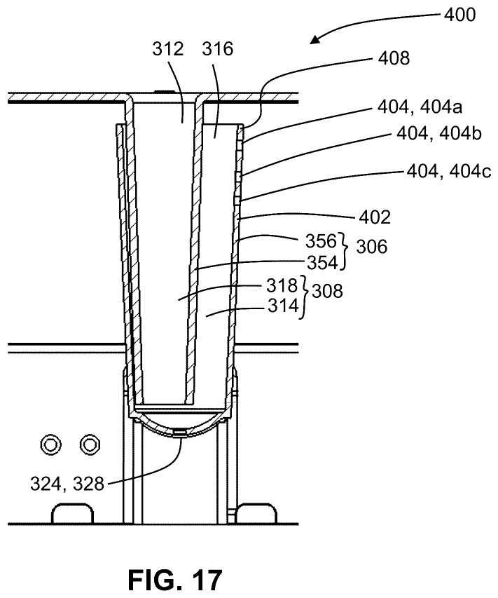

Reference is made to FIG. 17, which shows a pulse aeration system 400 that is a variant of the pulse aeration system 300 with the following differences as compared to the pulse aeration system 300. The gas flow path 308 of the pulse aeration system 400 may be referred to as a multi-inlet gas flow path, since it has a plurality of gas inlets 310.

In the embodiment shown, the first flow path portion 314 is defined at least in part by a peripheral wall, shown at 402. At least one of the plurality of gas inlets 310 in the embodiment shown is at least one peripheral aperture 404 in the peripheral wall 402. The at least one peripheral aperture 404 is positioned below the first end 316 of the first flow path portion 314 such that there is some gas upstream from the at least one peripheral aperture 404.

In the embodiment shown, the flow path structure 306 includes the riser conduit 354 that defines the second flow path portion 318 and the barrier 320, and the cup 356 that surrounds the riser conduit 354 so as to define the first flow path portion 314 and the plurality of gas inlets 310. The peripheral wall 402 that contains the at least one peripheral aperture 404 is a peripheral wall of the cup 356 below an upper end 408 of the cup 356.

In an embodiment (such as the embodiment shown in FIG. 17), the at least one peripheral aperture 404 is a plurality of peripheral apertures 404, which includes a first subset 404a of peripheral apertures 404, each having a first cross-sectional area A1, and a second subset 404b of peripheral apertures 404, positioned below the first subset 404a of peripheral apertures 404, and each having a second cross-sectional area A2 that is smaller than the first cross-sectional area A1. In the embodiment shown, the plurality of peripheral apertures 404 further includes an optional third subset 404c of peripheral apertures 404, each having a third cross-sectional area A3 that is smaller than the second cross-sectional area A2.

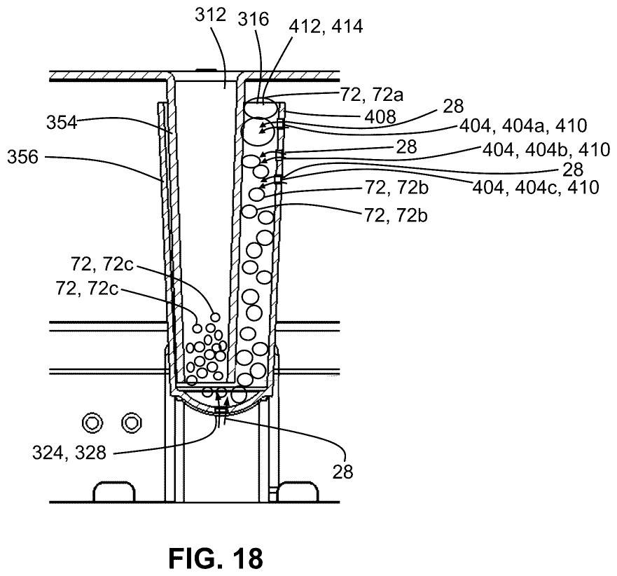

As with the embodiment shown in FIGS. 12-16C, during a gas release event, the sludge outlet 324 in the embodiment in FIG. 17 is a first retentate inlet 328. Additionally, the flow path structure 306 further includes at least one second retentate inlet 410. The at least one second retentate inlet 410 is positioned to permit retentate 28 to enter the multi-inlet gas flow path 308 at a position to interact with the gas during a gas release event so as to break up bubbles 72 of the gas from bubbles 72a of a first size into smaller bubbles (i.e. bubbles of a second size 72b that are smaller than the bubbles 72a of the first size), as represented in FIG. 18.

The at least one peripheral aperture 404 may optionally constitute the at least one second retentate inlet 410.

By making the second subset 404b of peripheral apertures 404 smaller in area than the first subset 404a of peripheral apertures 404, progressively less of the retentate 28 enters the gas flow path 308 as the gas moves downstream in the first flow path portion 314. This reduces the speed with which the retentate 28 will form a seal again which would end a gas release event, thereby blocking further air flow past the barrier bottom 322. By making the third subset 404c of peripheral apertures 404 smaller in area than the second subset 404b of peripheral apertures 404, progressively less of the retentate 28 enters the gas flow path 308 as the gas moves further downstream in the first flow path portion 314.

It will be noted that the first retentate inlet 328 permits the entry of retentate 28 into the gas flow path 308 to further reduce the size of the bubbles 72b of the second size into even smaller bubbles 72c of a third size that is smaller than the bubbles 72b of the second size. This provides an even greater advantage over systems that generate large bubbles, since a volume of gas that is broken into a greater number of smaller bubbles has more surface area to help clean the at least one filtration membrane, as compared to if the volume of gas is broken into fewer, larger bubbles.

Optionally, the plurality of gas inlets 310 may further include an opening 412 at the upper end 408 of the cup 356. Thus it may be said that, in some embodiments, the plurality of gas inlets 310 include a top aperture 414 at the upper end 408 of the cup 356, and the aforementioned at least one peripheral aperture 404 in the peripheral wall 402 of the cup 356 below the upper end 408 of the cup 356.

The dimensions of the sludge outlet described in relation to the flow path aperture 110, may also be applied to the sludge outlet 324 in the embodiment shown in FIGS. 12-16C, and the embodiment shown in FIGS. 17-18. For example, an area of the sludge outlet 324 may be between 2% and 12% of an area of the multi-inlet gas flow path 308 at the barrier bottom 322, and a minimum cross dimension of the sludge outlet 324 may be between 3 mm and 8 mm.

While it has been described for the sludge outlet 110 to be sized to seal the second flow path portion 102b within a selected range of time after the gas release event begins, and that the area of the sludge outlet 110 is selected so as to prevent more than a 10% variation in each of a magnitude of successive ones of the gas release events, a frequency of the gas release events, and periods between successive ones of the gas release events, similarly, the first retentate inlet 328 and the at least one second retentate inlet 410 may optionally be sized to seal the second flow path portion within a selected range of time after the gas release event begins, and the area of the first retentate inlet 328 and the area of the at least one second retentate inlet 410 may optionally be selected so as to prevent more than a 10% variation in each of a magnitude of successive ones of the gas release events, a frequency of the gas release events, and periods between successive ones of the gas release events.

Worded another way, the first retentate inlet 328 and the at least one second retentate inlet 410 may be sized to seal the second flow path portion 314 within a selected range of time after the gas release event begins, such that the pulse aeration system 400 delivers gas bubbles with repeatable cycles that are not random.

The method 200 described with respect to FIG. 11 has been described using the aeration system 11 to exemplify structure that is used during the execution of the method. It will be noted that the method 200 may be carried out using the pulse aeration system 300 shown in FIGS. 12-16D or the pulse aeration system 400 shown in FIGS. 17 and 18.

The embodiments of the disclosures described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the disclosure, therefore, is only to be limited by the claims appended hereto and any amendments made thereto.

What is claimed is:

1. A pulse aeration system for mounting in a tank for use with an immersed filtration system, the pulse aeration system comprising:
a chamber housing defining a chamber, the chamber having a flow path structure that defines a multi-inlet gas flow path having a plurality of gas inlets thereby rendering the multi-inlet gas flow path an open channel, and having a flow path outlet, wherein the multi-inlet gas flow path includes a first flow path portion that extends downward downstream from a first end thereof, and a second flow path portion that extends upwardly upstream from the flow path outlet and downstream from the first flow path portion, the flow path structure defining a barrier that is fluidically between the first and second flow path portions,
wherein the barrier has a barrier bottom that is positioned at a selected level in the chamber so as to permit a gas release event during which the gas is released up the second flow path portion where the gas come from the first flow path portion when a gas level of the gas in the flow path reaches below the barrier bottom, wherein the flow path outlet is positioned for release of the gas into the tank so as to defoul at least one filtration membrane in the tank,
wherein the multi-inlet gas flow path has a bottom, and wherein the flow path structure includes a sludge outlet proximate the bottom of the multi-inlet gas flow path to permit sludge in the flow path structure to fall therethrough,
wherein the chamber has a bottom that is open beneath the sludge outlet so as to permit any sludge that falls through the sludge outlet to leave the chamber,
wherein the sludge outlet is a first retentate inlet thereby permitting retentate to enter the multi-inlet gas flow path, and wherein the flow path structure further includes at least one second retentate inlet that is positioned to permit retentate to enter the multi-inlet gas flow path at a position to interact with the gas during a gas release event so as to break bubbles present in the gas from a first size into a second size that is smaller than the first size.

2. The pulse aeration system as claimed in claim 1, wherein the first retentate inlet and the at least one second retentate inlet are sized to seal the second flow path portion within a selected range of time after the gas release event begins, such that the pulse aeration system delivers gas bubbles with repeatable cycles that are not random.

3. The pulse aeration system as claimed in claim 1, wherein the first flow path portion is defined at least in part by a peripheral wall,
wherein at least one of the plurality of gas inlets is at least one peripheral aperture in the peripheral wall,
wherein the at least one peripheral aperture is positioned below the first end of the first flow path portion, and
wherein the at least one second retentate inlet includes the at least one peripheral aperture.

4. The pulse aeration system as claimed in claim 1, wherein the flow path structure includes a riser conduit that defines the second flow path portion and the barrier, and a cup that surrounds the riser conduit so as to define the first flow path portion and the plurality of gas inlets, wherein the sludge outlet is at a bottom of the cup.

5. The pulse aeration system as claimed in claim 4, wherein at least one of the plurality of gas inlets is at least one peripheral aperture in a peripheral wall of the cup below an upper end of the cup.

6. The pulse aeration system as claimed in claim 5, wherein the at least one peripheral aperture is a plurality of peripheral apertures including a first subset of peripheral apertures, each having a first cross-sectional area, and a second subset of peripheral apertures, positioned below the first subset of peripheral apertures, and each having a second cross-sectional area that is smaller than the first cross-sectional area.

7. The pulse aeration system as claimed in claim 4, wherein the plurality of gas inlets include a top aperture at an upper end of the cup, and at least one peripheral aperture in a peripheral wall of the cup below the upper end of the cup.

8. The pulse aeration system as claimed in claim 1, wherein at least one of the gas inlets is positioned proximate a bottom of the multi-inlet gas flow path and is directly fluidically connected to a gas feed conduit for transporting the gas directly into the first flow path portion from a gas source.

9. The pulse aeration system as claimed in claim 1, wherein an area of the sludge outlet is between 2% and 12% of an area of the multi-inlet gas flow path at the barrier bottom, and wherein a minimum cross dimension of the sludge outlet is between 3 mm and 8 mm.

10. The pulse aeration system as claimed in claim 1, wherein the first retentate inlet and the at least one second retentate inlet are sized to seal the second flow path portion within a selected range of time after the gas release event begins, and wherein the area of the first retentate inlet and the area of the at least one second retentate inlet are selected so as to prevent more than a 10% variation in each of a magnitude of successive ones of the gas release events, a frequency of the gas release events, and periods between successive ones of the gas release events.

11. The pulse aeration system as claimed in claim 1, further comprising:
a distributor that is positioned on top of the flow path outlet, wherein the distributor includes a plurality of distributor outlets that are oriented so as to distribute gas leaving the flow path outlet in a plurality of directions, so as to distribute the gas to a first side of the at least one filtration membrane and to a second side of the at least one filtration membrane.

12. The pulse aeration system as claimed in claim 1, wherein the
the first retentate inlet is positioned such that the retentate entering the gas flow path breaks bubbles of the second size into bubbles of a third size that is smaller than the second size.

13. A method for defouling at least one filtration membrane in a membrane module that is immersed in a tank containing a retentate, the method comprising:
providing a pulse aeration system as claimed in claim 1;
introducing gas into the chamber so as to lower a level of the retentate in the chamber, such that, after a selected period of time, the gas lowers the level of the retentate to break a hydraulic seal at the barrier bottom, thereby releasing some of the gas past the barrier bottom to exit the flow path outlet, in such a way that the gas passes along the plurality of filtration membranes so as to defoul the at least one filtration membrane,
wherein each of a magnitude of successive ones of the gas release events, a frequency of the gas release events, and the selected period of time between successive moments upon which the hydraulic seal is broken varies by less than 10%.

14. The method as claimed in claim 13, wherein the at least one membrane is a plurality of hollow-fiber membranes, wherein the plurality of hollow-fiber membranes are each mounted longitudinally between a first connection point to a first header and a second connection point to a second header, wherein the hollow-fiber membranes have more than 2% slack to permit lateral movement of the hollow-fiber membranes.

15. The method as claimed in claim 13, wherein the introducing step introduces gas at a constant gas flow rate into the chamber, and wherein after a gas release event in which the some of the gas is released past the barrier bottom, the retentate enters into the multi-inlet gas flow path through the sludge outlet and at least one of the plurality of gas inlets to reform the hydraulic seal.

16. A pulse aeration system for mounting in a tank for use with an immersed filtration system, the pulse aeration system comprising:
a chamber housing defining a chamber, the chamber having a flow path structure that defines a gas flow path having at least one gas inlet and a flow path outlet, wherein the at least one gas inlet includes at least one bottom gas inlet that is positioned proximate a bottom of the gas flow path, thereby rendering the gas flow path an open channel, and wherein the at least one gas inlet is directly fluidically connected to a gas feed conduit for transporting a gas into the gas flow path from a gas source,
wherein the gas flow path includes a first flow path portion that extends downward downstream from a first end thereof, and a second flow path portion that extends upwardly upstream from the flow path outlet and downstream from the first flow path portion, the flow path structure defining a barrier that is fluidically between the first and second flow path portions,
wherein the barrier has a barrier bottom that is positioned at a selected level in the chamber so as to permit a gas release event during which the gas is released up the second flow path portion from the first flow path portion, when a gas level of the gas in the flow path reaches below the barrier bottom,
wherein the flow path outlet is positioned for release of the gas into the tank so as to defoul at least one filtration membrane in the tank,
wherein the flow path structure includes a sludge outlet proximate the bottom of the gas flow path to permit sludge in the flow path structure to fall therethrough,
wherein the chamber has a bottom that is open beneath the sludge outlet so as to permit any sludge that falls through the sludge outlet to leave the chamber,
wherein the sludge outlet is a first retentate inlet thereby permitting retentate to enter the gas flow path, so as to break bubbles present in the gas from a first size into a second size that is smaller than the first size,
wherein the at least one bottom gas inlet is positioned upstream from the barrier so as to release the gas up the first flow path portion outside of the gas release event, but is positioned proximate to the barrier bottom such that the gas that is transported into the gas flow path from the at least one bottom gas inlet during the gas release event is at least in part carried by a flow of gas and retentate in the gas flow path into and up the second flow path portion.

17. The pulse aeration system as claimed in claim 16, wherein the first retentate inlet is sized to seal the second flow path portion within a selected range of time after the gas release event begins, such that the pulse aeration system delivers gas bubbles with repeatable cycles that are not random.

18. The pulse aeration system as claimed in claim 16, wherein the first retentate inlet is sized to seal the second flow path portion within a selected range of time after the gas release event begins, and wherein the area of the first retentate inlet is selected so as to prevent more than a 10% variation in each of a magnitude of successive ones of the gas release events, a frequency of the gas release events, and periods between successive ones of the gas release events.

19. The pulse aeration system as claimed in claim 16, further comprising:
a distributor that is positioned on top of the flow path outlet, wherein the distributor includes a plurality of distributor outlets that are oriented so as to distribute gas leaving the flow path outlet in a plurality of directions, so as to distribute the gas to a first side of the at least one filtration membrane and to a second side of the at least one filtration membrane.

20. The pulse aeration system as claimed in claim 16, the gas feed conduit has a bottom that is open such that there is retentate present in the gas feed conduit, and wherein a volume of the gas is present in the gas feed conduit,
wherein a flow of gas through the flow path outlet during the gas release event reduces pressure in the gas flow path, which in turn generates a pressure imbalance in the gas feed conduit between the retentate therein and the volume of the gas therein, which in turn drives at least a portion of the volume of the gas out through the at least one gas inlet into the gas flow path.
